(19) United States
(12) Patent Application Publication
(10) Pub. No.: US 2012/0174837 A1
(43) Pub. Date: Jul. 12, 2012

(54) TILTABLE NOZZLE ASSEMBLY FOR AN OVERFIRE AIR PORT IN A COAL BURNING POWER PLANT

(76) Inventors: JIEFENG SHAN, Brdgewater, NJ (US); Sergey Kaushansky, Livingston, NJ (US)

(21) Appl. No.: 13/277,492

(22) Filed: Oct. 20, 2011

Related U.S. Application Data
(60) Provisional application No. 61/430,355, filed on Jan. 6, 2011.

(51) Int. Cl. F23L 9/02; B23P 11/00; F23C 5/06; F23D 1/00; F23K 3/02

(52) U.S. Cl. 110/347; 110/265; 110/313; 110/104 R; 431/189; 29/428

(57) ABSTRACT

A combustor assembly in a coal burning power plant includes a combustor housing that defines a combustion zone in which pulverized coal is burned, at least one burner that introduces pulverized coal into the combustion zone, and an overfire air port that injects air into the combustor housing above the combustion zone, the overfire air port being generally not movable with respect to the combustor housing. The combustor assembly further includes a nozzle assembly associated with the overfire air port. The nozzle assembly includes a flow directing structure disposed within the overfire air port, which flow directing structure is tiltable with respect to the overfire air port to effect a change in a flow direction of the air being injected into the combustor housing through the overfire air port.

### CROSS REFERENCE TO RELATED APPLICATION

This application claims the benefit of U.S. Provisional Patent Application Ser. No. 61/430,355, filed Jan. 6, 2011, entitled “TILTABLE OVERFIRE AIR MECHANISM FOR WALL-FIRED AND ARCH-FIRED UTILITY BOILERS”, the entire disclosure of which is incorporated by reference herein.

### FIELD OF THE INVENTION

The present invention relates to an overfire air port in a coal burning power plant, and more particularly, to a nozzle assembly for use in an overfire air port that is tiltable to effect a change in a flow direction of air exiting the overfire air port.

### BACKGROUND OF THE INVENTION

In a coal burning power plant, working media comprising pulverized coal and carrier air is injected into a combustion zone of a combustor assembly through one or more burners. Additional air is provided into the combustor assembly through overfire air ports located above the combustion zone. The air introduced into the combustor assembly by the overfire air ports is injected into an area of the combustor assembly above the combustion zone known as a carbon monoxide (CO) burnout zone. The injection of the air from the overfire air ports into the CO burnout zone provides additional air that is necessary for complete combustion of the pulverized coal to occur, thus reducing the amount of CO given off by the power plant.

### SUMMARY OF THE INVENTION

In accordance with a first aspect of the present invention, a combustor assembly is provided in a coal burning power plant. The combustor assembly comprises a combustor housing that defines a combustion zone in which pulverized coal is burned, at least one burner that delivers pulverized coal into the combustion zone, and an overfire air port that injects air into the combustor housing above the combustion zone, the overfire air port being generally not movable with respect to the combustor housing. The combustor assembly further comprises a nozzle assembly associated with the overfire air port. The nozzle assembly includes a flow directing structure disposed within the overfire air port, which flow directing structure is tiltable with respect to the overfire air port to effect a change in a flow direction of the air being injected into the combustor housing through the overfire air port.

In accordance with a second aspect of the present invention, a method is provided for servicing a combustor assembly in a coal burning power plant that includes a combustor housing defining a combustion zone in which pulverized coal is burned. The method comprises installing a nozzle assembly into the combustor assembly, the nozzle assembly including a flow directing structure provided in an overfire air port that injects air into the combustor housing above the combustion zone. The overfire air port is generally not movable with respect to the combustor housing, and the flow directing structure is tiltable in a vertical direction with respect to the overfire air port to effect a change in a flow direction of the air being injected into the combustor housing through the overfire air port.

In accordance with a third aspect of the present invention, a method is provided for operating a coal burning power plant. Pulverized coal is introduced through at least one burner into a combustion zone defined within a combustor housing of the power plant. The pulverized coal is ignited in the combustion zone to create hot working gases. Air is injected into the combustor housing into a carbon monoxide burnout zone located above the combustion zone through an overfire air port, the overfire air port being generally not movable with respect to the combustor housing. A flow directing structure of a nozzle assembly provided within the overfire air port is tilted to effect a change in a flow direction of the air being injected into the carbon monoxide burnout zone through the overfire air port.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a schematic diagram of a combustor assembly for use in a coal burning power plant, the combustor assembly including an overfire air port according to an embodiment of the invention;

FIGS. 2 and 3 are perspective views of the overfire air port and a portion of a combustor housing of the combustor assembly schematically shown in FIG. 1, wherein a nozzle assembly provided in the overfire air port is illustrated in a first position in FIG. 2 and in a second position in FIG. 3; and

FIG. 4 is an enlarged perspective view of a flow directing structure of the nozzle assembly illustrated in FIGS. 2 and 3.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

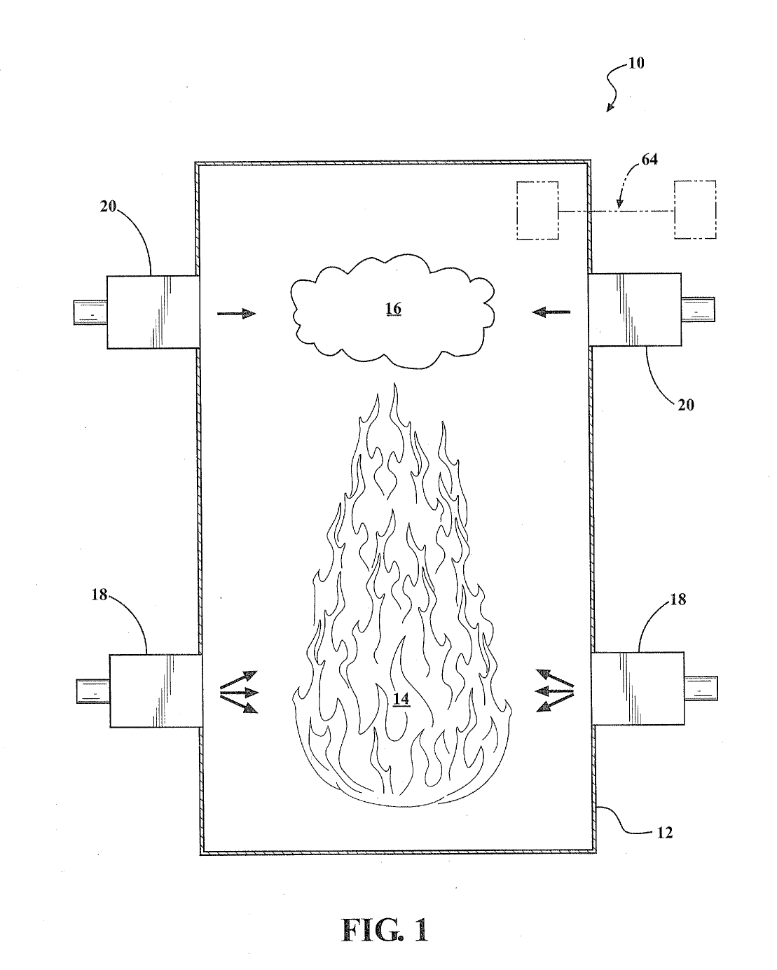

Referring now to FIG. 1, a combustor assembly 10, also known as a furnace, for use in a coal burning power plant according to an embodiment of the invention is schematically illustrated. The combustor assembly 10 comprises a combustor housing 12, which may be a water wall in some applications and which is a rigid structural member and may have any suitable size and shape. The combustor housing 12 defines a combustion zone 14 in which working media comprising pulverized coal and carrier air is burned. The combustor housing 12 further defines a carbon monoxide (CO) burnout zone 16 above the combustion zone 14. It is noted that the power plant may include more than one combustor assembly 10, and that the remaining combustor assemblies of the power plant may be substantially similar to the one described herein and shown in FIG. 1.

The combustor assembly 10 further comprises a plurality of burners 18 that introduce the working media into the combustor housing 12, i.e., into the combustion zone 14. The combustor assembly 10 may include any suitable number of burners 18, and the burners 18 may be positioned at any suitable location for injecting the working media into the combustion zone 14. Further, the burners 18 may be tiltable with respect to the combustor housing 12 to effect a change in a flow direction of the working media being introduced into the combustion zone 14 through the burners 18. For additional information on tilting of the burners 18, see, for example, U.S. Published Patent Application No. 2011/0048293, published Mar. 3, 2011 and entitled “NOZZLE FOR FEEDING COMBUSTION MEDIA INTO A FURNACE”, the entire disclosure of which is hereby incorporated by reference herein. It is noted that, according to an alternate embodiment, the burners 18 may introduce only pulverized coal into the combustor housing 12, e.g., in an embodiment where the burner 18 comprises a conveyor structure.

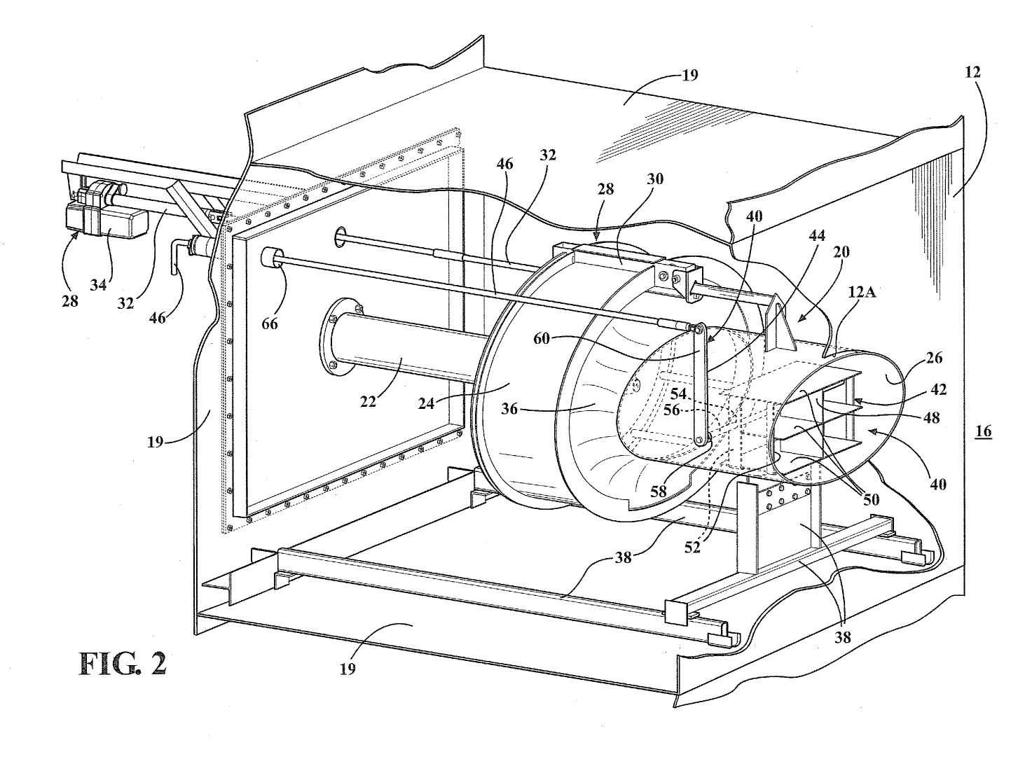

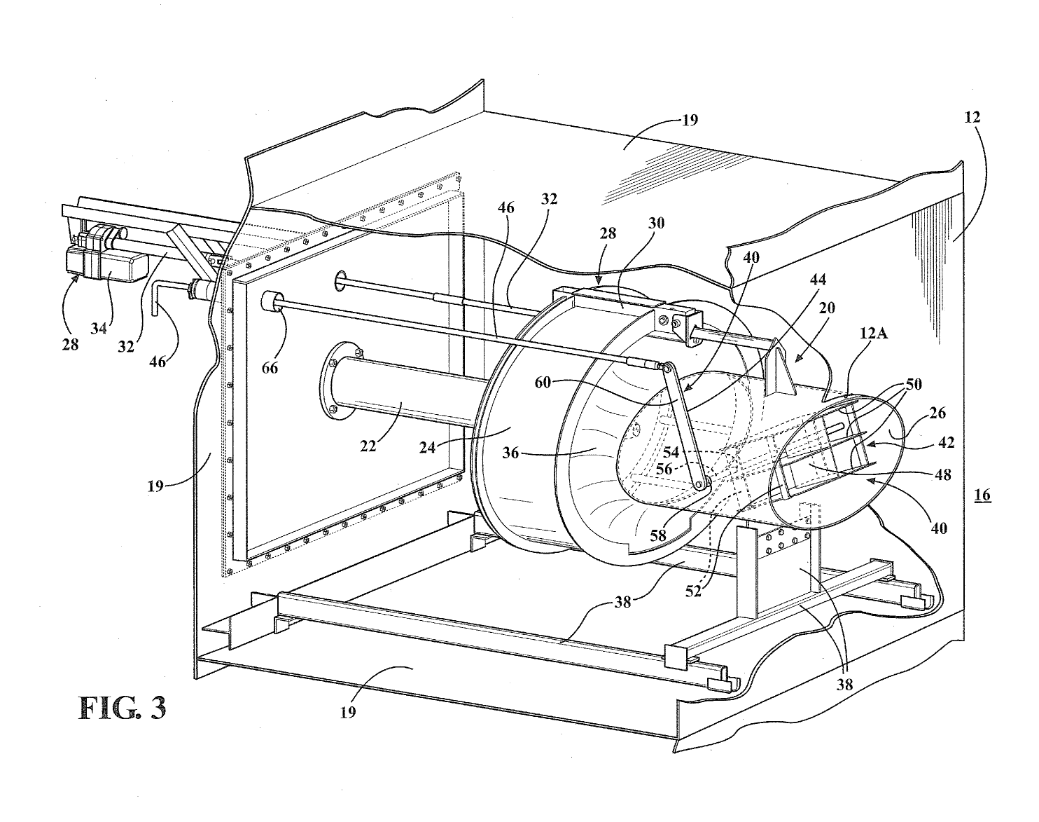

The combustor assembly 10 also includes a plurality of overfire air ports 20. The overfire air ports 20 inject air into the CO burnout zone 16, i.e., the overfire air ports 20 inject air above the combustion zone 14. The air injected by the overfire air ports 20 may comprise secondary air, i.e., air provided from a secondary source, such as a heater, that is supplied to the overfire air ports 20 via a windbox 19 (FIGS. 2 and 3) associated with each of the overfire air ports 20, as will be described below.

Referring now to FIGS. 2 and 3, one of the overfire air ports 20 is shown, it being understood that the remaining overfire air ports 20 of the combustor assembly 10 may be generally identical to the one illustrated in FIGS. 2 and 3 and described herein. The overfire air port 20 includes a support structure 22 that is fixedly mounted to the windbox 19 so as to substantially prevent movement between the overfire air port 20 and the windbox 19. The overfire air port 20 further includes an air receiving unit 24 and an air injecting unit 26. The air receiving unit 24 receives the air for injection into the CO burnout zone 16, which air is hereinafter referred to as “overfire air”, and the air injecting unit 26 injects the overfire air into the CO burnout zone 16. The air injecting unit 26 may comprise a circular or ovular cross sectional shape and extends in a direction toward the CO burnout zone 16, as shown in FIGS. 2 and 3. The air injecting unit 26 is securely received in an aperture 12A of the combustor housing 12 such that the overfire air port 20 is generally not movable with respect to the combustor housing 12.

The overfire air port 20 further includes a damper assembly 28 that is well known in the art and is used to selectively and proportionally allow air to enter the air receiving unit 24. The damper assembly 28 includes a perforated plate (not shown) provided in a damper housing 30, a drive rod 32 coupled to the damper housing 30 for sliding the damper housing 30 and exposing the perforated plate, and an electric drive unit 34 that used to drive the drive rod 32. As will be apparent to those skilled in the art, the perforated plate is provided with holes that allow air to pass therethrough. The damper housing 30 is moved linearly by the electric drive unit 34 via the drive rod 32. Movement of the damper housing 30 selectively and proportionally exposes the holes in the perforated plate so as to allow air to enter the air receiving unit 24 from the windbox 19.

The overfire air port 20 illustrated in FIGS. 2 and 3 also includes a bell mouth 36 located between the air receiving unit 24 and the air injecting unit 26. The bell mouth 36 effects a flow of the overfire air in a direction from the air receiving unit 24 toward the air injecting unit 26, as will be apparent to those skilled in the art. The overfire air port 20 is further associated with a support assembly 38 that engages the windbox 19 and the combustor housing 12 to provide additional structural support for the overfire air port 20.

The combustor assembly 10 further comprises a nozzle assembly 40 associated with the overfire air port 20, see FIGS. 2 and 3. The nozzle assembly 40 comprises a flow directing structure 42, a pivot mechanism 44, and a handle structure 46. The flow directing structure 42 is located in the air injecting unit 26 downstream from the bell mouth 28 and is tiltable with respect to the overfire air port 20 to effect a change in a flow direction of the overfire air being injected into the CO burnout zone 16 through the overfire air port 20, as will be described herein.

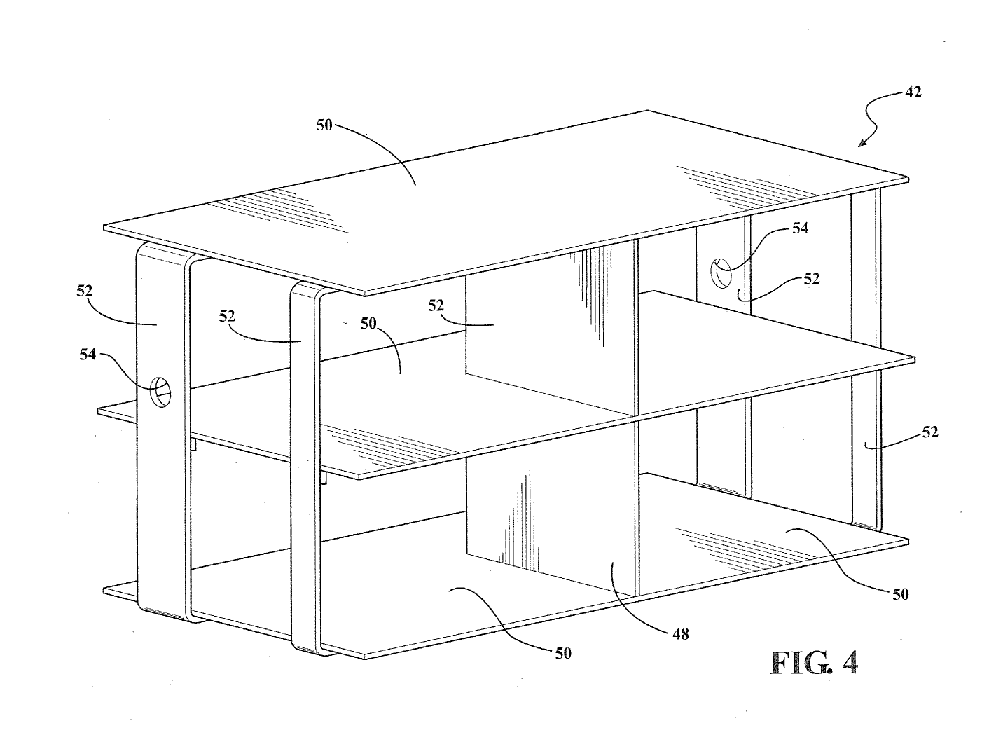

Referring to FIG. 4, the flow directing structure 42 comprises a frame 48 that supports a plurality of vanes 50. The frame 48 is a rigid member and comprises a plurality of support members 52, which are coupled to and provide support for the vanes 50. The vanes 50 comprise generally planar plates that provide flow direction for the overfire air being injected into the CO burnout zone 16 by the overfire air port 20, as will be described herein.

As shown in FIGS. 2-4, rearward support members 52 of the frame 48, i.e., support members 52 that are located further from the combustor housing 12, include apertures 54 formed therein. The apertures 54 receive a rod 56 (see FIGS. 2 and 3) of the pivot mechanism 44 therein. The rod 56 is fixedly coupled to the support members 52 within the apertures 54, such that rotation of the rod 56 about an axis of rotation of the rod 56 causes a corresponding tilting of the flow directing structure 42 in a vertical direction, as will be described herein. The rod 56 extends through respective openings 58 (only one opening 58 is shown in FIGS. 2 and 3) formed in the air injecting unit 26 of the overtire air port 20. The rod 56 is rotatable within the openings 58 without causing corresponding rotation of the air injecting unit 26, i.e., the diameter of the rod 56 is slightly smaller than the diameters of the openings 58.

The rod 56 is also fixedly coupled to a pivot bracket 60 of the pivot mechanism 44 such that rotation of the pivot bracket 60 causes corresponding rotation of the rod 56, see FIGS. 2 and 3. The pivot bracket 60 is in turn coupled to the handle structure 46. The coupling of the pivot bracket 60 to the handle structure 46 is such that horizontal movement of the handle structure 46, i.e., linear movement in a direction toward or away from the CO burnout zone 16, causes a corresponding rotation of the pivot bracket 60. That is, in the embodiment shown in FIGS. 2 and 3, movement of the handle structure 46 in a direction toward the CO burnout zone 16 causes rotation of the pivot bracket 60 in a clockwise direction, which causes a corresponding tilting in the vertical direction of the flow directing structure 42 in a direction toward the combustion zone 14. Movement of the handle structure 46 in a direction away from the CO burnout zone 16 causes rotation of the pivot bracket 60 in a counter-clockwise direction, which causes a corresponding tilting in the vertical direction of the flow directing structure 42 in a direction away from the combustion zone 14. It is noted that other configurations could be used to effect rotation of the pivot bracket 60 and the flow directing structure 42.

The handle structure 46 extends through an orifice 66 formed in the windbox 19 such that the handle structure 46 is manipulatable from outside of the windbox 19 and from the outside of the combustor housing 12, see FIGS. 2 and 3. Hence, the flow directing structure 42 can be effectively tilted toward or away from the combustion zone 14 from outside of the combustor housing 12 using the handle structure 46. That is, the handle structure 46 can be selectively pushed toward the combustor housing 12 and pulled away from the combustor housing 12 to effect tilting of the flow directing structure 42 in the vertical direction, i.e., toward and away from the combustion zone 14. In the embodiment shown, pushing the handle 46 structure toward the combustor housing 12 causes the flow directing structure 42 to rotate or tilt in a first direction within the overfire air port 20, i.e., in a clockwise direction in the embodiment shown, such that the air exiting the overfire air port 20 is angled toward the combustion zone 14. Further, pulling the handle structure 46 away from the combustor housing 12 causes the flow directing structure 42 to rotate or tilt in a second direction within the overfire air port 20, i.e., in a counter-clockwise direction in the embodiment shown, such that the air exiting the overfire air port 20 is angled away from the combustion zone 14.

During operation of the coal burning power plant, pulverized coal and a carrier gas comprising a transport medium, i.e., the carrier air, which are collectively referred to herein as working media, are introduced into the combustion zone 14 via the burners 18, which may be tilted as described in U.S. Patent Publication No. 2011/0048293 to change the flow direction of the working media being introduced.

Secondary air is provided into the windbox 19 from a secondary source, such as a heater, as noted above. The secondary air is provided into the windbox 19 at a higher pressure than a pressure within the combustor housing 12. When the damper assembly 28 is configured to allow air to pass into the air receiving units 24 of the overfire air ports 20, the pressure differential between the pressure of the secondary air in the windbox 19 and the pressure in the combustor housing 12 causes the secondary air to flow through the holes in the perforated plate and into the air receiving unit 24 of the overfire air port 20.

The overfire air ports 20 inject the secondary air, i.e., the overfire air, into the CO burnout zone 16 above the combustion zone 14. As discussed above, the handle structure 46 can be manipulated from the outside of the combustor housing 12 and the windbox 19 to change the flow direction of the overfire air being injected by the overfire air ports 20. Changing the flow direction of the air being injected by the overfire air ports 20 can impact the burning conditions of the working media within the combustor assembly 10, thus effecting a change in the amount of emissions, such as CO, unburned carbon, and NO_{X}, given off by the combustor assembly 10. For example, changing the flow direction of the overfire air being injected by the overfire air ports 20 can impact the residence time of sub-stoichiometric combustion of the working media, i.e., sub-stoichiometric combustion refers to the burning of pulverized coal with less air than is necessary to completely burn the pulverized coal, and can also impact the temperature profiles within the combustor assembly 10. Increasing the residence time of sub-stoichiometric combustion of the working media by tilting the flow directing structures 42 such that the overfire air injected by the overfire air ports 20 is introduced at a desired position within the combustor housing 12 is believed to lead to a reduction in NO_{X} and a change in unburned carbon and CO emissions.

Further, since each overfire air port 20 is associated with a separate handle structure 46, each flow directing structure 42 can be adjusted separately to fine tune conditions within the combustor assembly 10.

It is noted that a decision can be made as to whether to tilt the flow directing structure 42 such that the air exiting the overfire air ports 20 is to be angled toward the combustion zone 14 or away from the combustion zone 14 using a monitoring system 64 (see FIG. 1), which monitors at least one operating parameter within the combustor housing 12. The monitoring system 64 may monitor temperature profiles within the combustor housing 12, residence time of sub-stoichiometric combustion of the working media, CO, NO_{X}, or other emissions, etc.

The nozzle assembly 40 described above can be installed in an existing overfire air port 20 of an existing combustor assembly 10 during a servicing operation, which will now be described. If the nozzle assembly 40 is installed in an existing overfire air port 20 of an existing combustor assembly 10, the need for an entire replacement combustor assembly 10 or major renovations to an existing combustor assembly 10 in which tilting of overfire air is desired are avoided.

During a servicing operation, the interiors of the combustor housing 12 and the windbox 19 are accessed, or the windbox 19 can be removed from the combustor housing 12, such that access into the interior of the combustor housing 12 is not required. Openings 58 are drilled or otherwise formed in the air injecting unit 26 of the overfire air port 20 being serviced. An orifice 66 is also drilled or otherwise formed in the windbox 19 and the handle structure 46 of the nozzle assembly 40 is inserted through the orifice. The nozzle assembly 40 is installed in the combustor assembly 10 by positioning the flow directing structure 42 in the air injecting unit 26 of the overfire air port 20, which overfire air port 20 is generally not movable with respect to the combustor housing 12 and is located above the position of the combustion zone 14 during operation.

The rod 56 is then inserted through the openings 58 in the air injecting unit 26 and is secured to the flow directing structure 42 within the apertures 54 of the frame support members 52. The rod 56 is then secured to the pivot bracket 60, which is in turn coupled to the handle structure 46.

The combustor housing 12 and windbox 19 are then closed off, i.e., the access locations are closed, and any remaining steps are taken such that the combustor assembly 10 is ready for use. As described above, each serviced nozzle assembly 40 allows for effecting a change in a flow direction of the overfire air being injected into the CO burnout zone 16 through the receptive overfire air port 20 by tilting the flow directing structure 42 in the vertical direction with the handle structure 46.

While a particular embodiment of the present invention has been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combustor assembly in a coal burning power plant, the combustor assembly comprising:
a combustor housing that defines a combustion zone in which pulverized coal is burned;
at least one burner that introduces pulverized coal into the combustion zone;
an overfire air port that injects air into the combustor housing above the combustion zone, the overfire air port being generally not movable with respect to the combustor housing; and
a nozzle assembly associated with the overfire air port, the nozzle assembly including a flow directing structure disposed within the overfire air port and being tiltable with respect to the overfire air port to effect a change in a flow direction of the air being injected into the combustor housing through the overfire air port.

2. The combustor assembly of claim 1, wherein the overfire air port comprises an air injecting unit that injects the air into the combustor housing, the air injecting unit having one of a circular and an ovular cross sectional shape.

3. The combustor assembly of claim 1, wherein the flow directing structure comprises a frame that supports a plurality of vanes.

4. The combustor assembly of claim 1, wherein the nozzle assembly further comprises:
a pivot mechanism for tilting the flow directing structure in the overfire air port; and
a handle structure coupled to the pivot mechanism, the handle structure being manipulatable from outside of the combustor housing to effect tilting of the flow directing structure.

5. The combustor assembly of claim 4, wherein the handle structure can be selectively pushed toward the combustor housing and pulled away from the combustor housing to effect tilting of the flow directing structure in a vertical direction.

6. The combustor assembly of claim 5, wherein:
pushing the handle structure toward the combustor housing causes the flow directing structure to rotate in a first direction within the overfire air port such that the air exiting the overtire air port is angled one of toward the combustion zone and away from the combustion zone; and
pulling the handle structure away from the combustor housing causes the flow directing structure to rotate in a second direction within the overfire air port such that the air exiting the overfire air port is angled the other of toward the combustion zone and away from the combustion zone.

7. The combustor assembly of claim 1, wherein the at least one burner is tiltable to effect a change in a flow direction of the pulverized coal being introduced into the combustion zone through the at least one burner.

8. A method for servicing a combustor assembly in a coal burning power plant that includes a combustor housing defining a combustion zone in which pulverized coal is burned, the method comprising:
installing a nozzle assembly into the combustor assembly, the nozzle assembly including a flow directing structure provided in an overfire air port that injects air into the combustor housing above the combustion zone, the overfire air port being generally not movable with respect to the combustor housing; and
wherein the flow directing structure is tiltable in a vertical direction with respect to the overfire air port to effect a change in a flow direction of the air being injected into the combustor housing through the overfire air port.

9. The method of claim 8, wherein the overfire air port comprises an air injecting unit that injects the air into the combustor housing, the air injecting unit having one of a circular and an ovular cross sectional shape.

10. The method of claim 8, wherein the flow directing structure comprises a frame that supports a plurality of vanes.

11. The method of claim 8, wherein installing a nozzle assembly into the combustor assembly further comprises coupling a pivot mechanism of the nozzle assembly to the flow directing structure, and coupling a handle structure to the pivot mechanism, the handle structure being manipulatable from outside of the combustor housing to effect tilting of the flow directing structure in the vertical direction.

12. The method of claim 11, wherein the handle structure can be selectively pushed toward the combustor housing and pulled away from the combustor housing to effect tilting of the flow directing structure in the vertical direction.

13. A method for operating a coal burning power plant comprising:
introducing pulverized coal through at least one burner into a combustion zone defined within a combustor housing of the power plant;
igniting the pulverized coal in the combustion zone to create hot working gases;
injecting air into the combustor housing into a carbon monoxide burnout zone located above the combustion zone through an overfire air port, the overfire air port being generally not movable with respect to the combustor housing; and
tilting a flow directing structure of a nozzle assembly provided within the overfire air port to effect a change in a flow direction of the air being injected into the carbon monoxide burnout zone through the overfire air port.

14. The method of claim 13, wherein the overfire air port comprises an air injecting unit that injects the air into the carbon monoxide burnout zone, the air injecting unit having one of a circular and an ovular cross sectional shape.

15. The method of claim 13, wherein the flow directing structure comprises a frame that supports a plurality of vanes.

16. The method of claim 13, wherein tilting the flow directing structure comprises manipulating a handle structure located outside of the combustor housing to effect tilting of the flow directing structure in a vertical direction.

17. The method of claim 16, wherein the handle structure is selectively pushed toward the combustor housing or pulled away from the combustor housing to effect tilting of the flow directing structure in the vertical direction.

18. The method of claim 17, wherein:
pushing the handle structure toward the combustor housing causes the flow directing structure to rotate in a first direction within the overfire air port such that the air exiting the overfire air port is angled one of toward the combustion zone and away from the combustion zone; and
pulling the handle structure away from the combustor housing causes the flow directing structure to rotate in a second direction within the overfire air port such that the air exiting the overfire air port is angled the other of toward the combustion zone and away from the combustion zone.

19. The method of claim 18, further comprising monitoring at least one operating parameter within the combustor housing to determine whether to tilt the flow directing structure such that the air exiting the overfire air port is to be angled toward the combustion zone or away from the combustion zone.

20. The method of claim 13, further comprising changing a flow direction of the pulverized coal being introduced into the combustion zone through the at least one burner by tilting the at least one burner with respect to the combustor housing.
